(19) United States
(12) Patent Application Publication
(10) Pub. No.: US 2026/0167486 A1
(43) Pub. Date: Jun. 18, 2026

(54) HYDROGEN AND ALUMINUM SALT PRODUCTION VIA ALUMINUM-WATER REACTION

(71) Applicant: Tactical Edge Systems, Inc., Billerica, MA (US)

(72) Inventors: Mark Donahue, Littleton, MA (US); Erik Limpaecher, Concord, MA (US)

(21) Appl. No.: 19/424,091

(22) Filed: Dec. 17, 2025

Related U.S. Application Data
(60) Provisional application No. 63/734,846, filed on Dec. 17, 2024.

(51) Int. Cl. C01B 3/08; C01F 7/42

(52) U.S. Cl. CPC C01B 3/08; C01F 7/42

(57) ABSTRACT

The systems, compositions, and methods herein provide hydrogen and aluminum salt production through the reaction of aluminum with water, using anion donor chemicals and a corrosion agent, which eliminates the need for pre-activating aluminum and avoids the formation of water-insoluble aluminum hydroxide. Water can be combined with dissolved anion donor chemicals, a corrosion agent, and aluminum in a reaction vessel. The corrosion agent corrodes an aluminum oxide layer on the aluminum, exposing raw aluminum (Al₀) to water, and initiating a reaction that produces hydrogen gas, heat, and water-soluble aluminum salts. The evolved hydrogen can be captured for immediate use or storage. The produced aluminum salts can be removed and purified for use as a precursor chemical in various industrial applications. Related apparatus, techniques, and articles are also described.

### CROSS-REFERENCE TO RELATED APPLICATIONS

This application claims the benefit of U.S. Provisional Application No. 63/734,846, filed on Dec. 17, 2024, which is incorporated by reference herein in its entirety.

### TECHNICAL FIELD

The subject matter described herein relates to hydrogen and aluminum salt generation using aluminum and water.

### DESCRIPTION OF DRAWINGS

FIGS. 1A-1F illustrate an example implementation of a system and process for generating hydrogen and aluminum salt from aluminum and water;

FIGS. 2A-2B illustrate additional embodiments of the system and process of FIG. 1;

FIGS. 3A-3C illustrate a material dispenser configured within the reactor vessel of the system of FIGS. 1A-1F;

FIGS. 4A-4C illustrate an embodiment of the reactor vessel of the system of FIGS. 1A-1F configured to recirculate water;

FIGS. 5A-5B illustrate an embodiment of the reactor vessel of the system of FIGS. 1A-1F configured to include a cooling reservoir; and

FIGS. 6A-6B illustrate an embodiment of the reactor vessel of the system of FIGS. 1A-1F configured to filter water using pressurized hydrogen.

Like reference symbols in the various drawings indicate like elements.

### BACKGROUND

Hydrogen can be a vital resource for numerous industrial, energy, defense, and transportation applications due to its role as an energy carrier. Producing hydrogen using aluminum has been explored as an alternative to traditional methods due to the metal's high energy density and its ability to react with water to release hydrogen, however existing solutions require mechanically and/or chemically complex processes which consume costly materials, require costly equipment, and can often produce hazardous conditions during hydrogen production. Improved, safe, and scalable means of hydrogen production using aluminum are needed.

### SUMMARY

In general, systems, compositions, and methods for providing hydrogen and aluminum salt production are provided. In one embodiment, a mixture is provided and can include water, an anion donor composition, an aluminum corrosion agent, and an aluminum source. The aluminum source may not include activated alumina.

In some embodiments, the anion donor composition can include sodium citrate. In some embodiments, the anion donor composition can include vinegar, sodium acetate, lactic acid, lysine, or oxalic acid. In some embodiments, the anion donor composition can include citric acid, sodium chloride, potassium citrate, boric acid, sodium lactate, sodium acetate trihydrate, or tartaric acid. In some embodiments, the mixture can include from about 2 g to about 25 g of anion donor composition per 1 g of aluminum source. In some embodiments, the mixture can include from about 5 g to about 25 g of anion donor composition per 1 g of aluminum source. In some embodiments, the mixture can include from about 2 g to about 20 g of anion donor composition per 1 g of aluminum source.

In some embodiments, the mixture can include from about 3 g to about 8 g of anion donor composition per 1 g of aluminum source. In some embodiments, the mixture can include from about 5 g to about 15 g of anion donor composition per 1 g of aluminum source. In some embodiments, the mixture can include from about 15 g to about 25 g of anion donor composition per gram of aluminum source. In some embodiments, the mixture can include from about 10 g to about 20 g of anion donor composition per gram of aluminum source. In some embodiments, the mixture can include the anion donor composition at a concentration of from about 2 g/L to about 3000 g/L. In some embodiments, the mixture can include the anion donor composition at a concentration of from about 2 g/L to about 2000 g/L.

In some embodiments, the aluminum corrosion agent can include gallium. In some embodiments, the aluminum corrosion agent can be gallium-indium eutectic. In some embodiments, the mixture can include at least 0.01 g of aluminum corrosion agent per 1 g of aluminum source. In some embodiments, the mixture can include at most 2 g or at most 1 g of aluminum corrosion agent per 1 g of aluminum source. In some embodiments, the mixture can include from about 0.001 g to about 2 g of aluminum corrosion agent per 1 g of aluminum source. In some embodiments, the mixture can include from about 0.01 g to about 1 g of aluminum corrosion agent per 1 g of aluminum source. In some embodiments, the mixture can include from about 0.01 g to about 0.8 g of aluminum corrosion agent per 1 g of aluminum source. In some embodiments, the mixture can include about 0.6 g of aluminum corrosion agent per 1 g of aluminum source. In some embodiments, the aluminum source can be scrap aluminum. In some embodiments, the aluminum source can be an aluminum alloy. In some embodiments, the aluminum source can include from about 90% to about 100% aluminum. In some embodiments, the aluminum source can include about 93% aluminum.

In some embodiments, the water can be tap water. In some embodiments, the water can be purified water or deionized water. In some embodiments, the water can be ocean water.

In another aspect, a process of making hydrogen is provided. In one embodiment, the process can include providing a mixture comprising water and an anion donor composition into a reaction vessel. The process can also include adding to said mixture an aluminum corrosion agent and an aluminum source. The aluminum source may not include activated alumina. The process can further include collecting hydrogen gas formed by the reaction of said water with aluminum provided by said aluminum source.

In some embodiments, the reaction can reach completion within about 60 hours or less. In some embodiments, the reaction can reach completion within about 48 hours or less. In some embodiments, the reaction can reach completion within about 24 hours or less. In some embodiments, the reaction can reach completion within about 12 hours or less. In some embodiments, the reaction can reach completion within about 6 hours or less. In some embodiments, the reaction can reach completion within about 1 hour or less. In some embodiments, the reaction can reach completion within about 0.5 hour or less In some embodiments, the temperature of the mixture including the water and said anion donor composition can be about 25° C. or more. In some embodiments, the temperature of the mixture including said water and said anion donor composition can be less than 25° C. In some embodiments, the hydrogen can be continuously removed from the reaction vessel and captured in a separate storage vessel.

In some embodiments, the corrosion agent may not be consumed during the process. In some embodiments, the corrosion agent can be recovered after completion of the process. In some embodiments, the process further include adding cold water to the reaction vessel. In some embodiments, the cold water can be continuously added during the reaction to maintain a reaction temperature of from about 50° C. to about 70° C.

In some embodiments, the reaction vessel can further include a mechanical stirring device and at least one of the corrosion agent and the aluminum source can be positioned adjacent to the mechanical stirring device. In some embodiments, the mechanical stirring device can be positioned in a first location of the reactor vessel relative to a longitudinal axis extending through the reactor vessel. The mechanical stirring device can be configured to maintain contact between the corrosion agent and the aluminum source at the first location. In some embodiments, the hydrogen gas can be collected from a second location of the reactor vessel relative to the longitudinal axis. The second location can be opposite the first location. In some embodiments, the formation of the hydrogen gas can be initiated responsive to actuating the mechanical stirring device. In some embodiments, the reaction vessel can be fluidically coupled to a heat exchanger configured to receive steam evolved during the reaction.

In some embodiments, the anion donor composition can include sodium citrate. In some embodiments, the anion donor composition can include vinegar, sodium acetate, lactic acid, lysine, or oxalic acid. In some embodiments, the anion donor composition can include citric acid, sodium hydroxide, sodium chloride, potassium citrate, boric acid, sodium lactate, sodium acetate trihydrate, or tartaric acid. In some embodiments, the process can include from about 2 g to about 25 g of anion donor composition per 1 g of aluminum source. In some embodiments, the process can include from about 5 g to about 25 g of anion donor composition per 1 g of aluminum source. In some embodiments, the mixture including water and an anion donor composition can include from about 2 g to about 20 g of anion donor composition per 1 g of aluminum source.

In some embodiments, the mixture including water and an anion donor composition can include from about 3 g to about 8 g of anion donor composition per 1 g of aluminum source. In some embodiments, the mixture including water and an anion donor composition can include from about 5 g to about 15 g of anion donor composition per 1 g of aluminum source. In some embodiments, the mixture including water and an anion donor composition can include from about 15 g to about 25 g of anion donor composition per gram of aluminum source. In some embodiments, the mixture including water and an anion donor composition can include from about 10 g to about 20 g of anion donor composition per gram of aluminum source. In some embodiments, the mixture including water and an anion donor composition can include the anion donor composition at a concentration of from about 2 g/L to about 3000 g/L. In some embodiments, the mixture including water and an anion donor composition can include the anion donor composition at a concentration of from about 2 g/L to about 2000 g/L

In some embodiments, the aluminum corrosion agent can include gallium. In some embodiments, the aluminum corrosion agent can be gallium-indium eutectic. In some embodiments, the mixture can include at least 0.01 g of aluminum corrosion agent per 1 g of aluminum source. In some embodiments, the mixture can include at most 2 g or at most 1 g of aluminum corrosion agent per 1 g of aluminum source. In some embodiments, the mixture can include from about 0.001 g to about 2 g of aluminum corrosion agent per 1 g of aluminum source. In some embodiments, the mixture can include from about 0.01 g to about 1 g of aluminum corrosion agent per 1 g of aluminum source. In some embodiments, the mixture can include from about 0.01 g to about 0.8 g of aluminum corrosion agent per 1 g of aluminum source. In some embodiments, the mixture can include about 0.6 g of aluminum corrosion agent per 1 g of aluminum source.

In some embodiments, the aluminum source can be scrap aluminum. In some embodiments, the aluminum source can be an aluminum alloy. In some embodiments, the aluminum source can include from about 90% to about 100% aluminum. In some embodiments, the aluminum source cam include about 93% aluminum. In some embodiments, the water can be tap water. In some embodiments, the water can be purified water or deionized water. In some embodiments, the water can be ocean water.

In some embodiments, the process can result in production of an aluminum salt as a byproduct. In some embodiments, the salt can include a citrate, acetate, tartrate, oxalate, lactate, borate, hydroxide, or chloride.

### DETAILED DESCRIPTION

Existing methods of hydrogen production, such as electrolysis and natural gas steam reforming, present significant challenges. Electrolysis requires purified water and consumes massive amounts of electrical energy. For example, existing electrolysis methods can require approximately 50 kWh of electricity for every kilogram of hydrogen produced, making hydrogen production cost-prohibitive when it is produced based on electricity from a renewable or local power grid source. Steam reforming necessitates large-scale chemical plants and access to natural gas, limiting its feasibility in remote or infrastructure-constrained environments. Transporting and storing the resulting hydrogen gas requires heavy compressed gas cylinders, which are classified as hazardous materials (HAZMAT). These cylinders add logistical complexity and require reverse logistics for handling and return.

Existing aluminum-based systems face critical limitations. Conventional approaches involve “activating” aluminum by disrupting its passivating aluminum oxide layer, a process that requires the use of expensive activation materials such as gallium, indium, tin, or bismuth. These materials not only increase costs but also introduce supply chain vulnerabilities, as many are produced by potential economic competitors or military adversaries. The activation process results in water-reactive aluminum HAZMAT, which is subject to transport and storage safety limitations.

The subject matter herein can overcome these limitations by introducing a novel approach for producing hydrogen from aluminum without pre-activating the aluminum metal. The approach described herein can eliminate the need to transport or store hazardous, activated aluminum, and can avoid the formation of aluminum hydroxide. Instead, the subject matter herein can be configured to produce water-soluble aluminum salts, such as aluminum citrate, which not only simplify reactor operation but also offer significant commercial value. Aluminum salts can be used as chemical inputs in numerous industries, including oil and gas, pharmaceuticals and deodorants, water purification, vaccine production, and paper production. The subject matter herein can achieve high scalability and operational safety by enabling point-of-need hydrogen and/or aluminum salt production using inexpensive, readily available feedstock items like aluminum and water. As a result, the complexity of reactors for managing the reaction can be simplified and the use of expensive activation metals eliminated. In addition, such activation metals can be reused indefinitely. Hydrogen production via the subject matter described herein is particularly advantageous in applications or environments where there are significant infrastructure and logistical constraints, thus making it ideal for applications such as construction, agriculture, mining, oil rigs, and military operations.

The subject matter herein provides systems and methods for producing hydrogen and aluminum salts by reacting aluminum with water, addressing the limitations of existing hydrogen production technologies described above, and avoiding the expensive and toxic processes currently used to produce aluminum salts. Unlike prior systems that rely on pre-activated aluminum and produce water-insoluble aluminum hydroxide as a byproduct, the systems and methods herein employ a simpler, safer, and more cost-effective approach for hydrogen and aluminum salt production. The subject matter herein provides a novel and efficient systems and methods for producing hydrogen and aluminum salts through the reaction of aluminum with water, using an innovative combination of anion donor chemicals and a corrosion agent. The system and methods described herein avoid the challenges of pre-activating aluminum, eliminates the production of water-insoluble aluminum hydroxide, and enables scalable, point-of-need hydrogen generation.

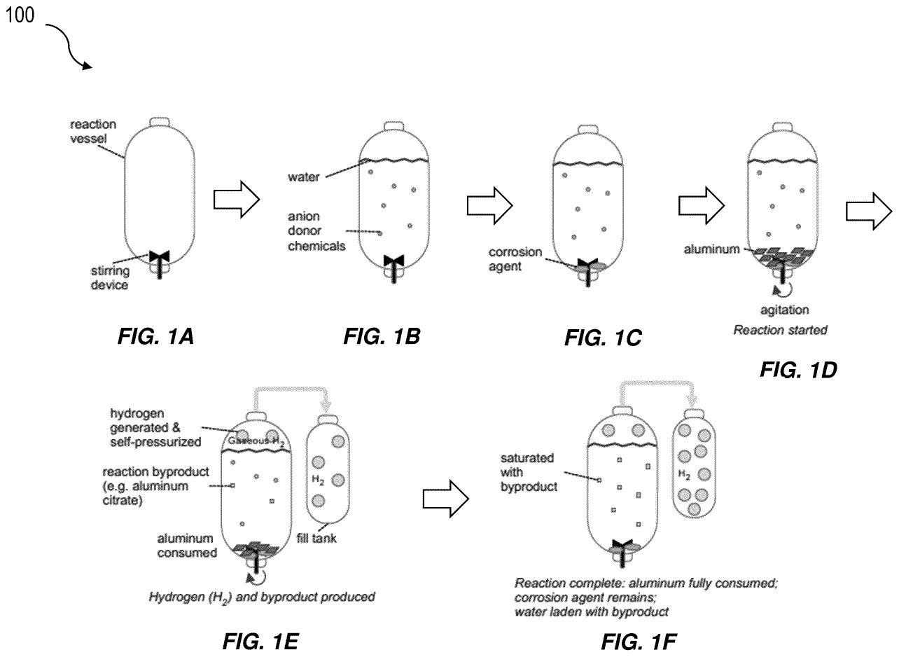

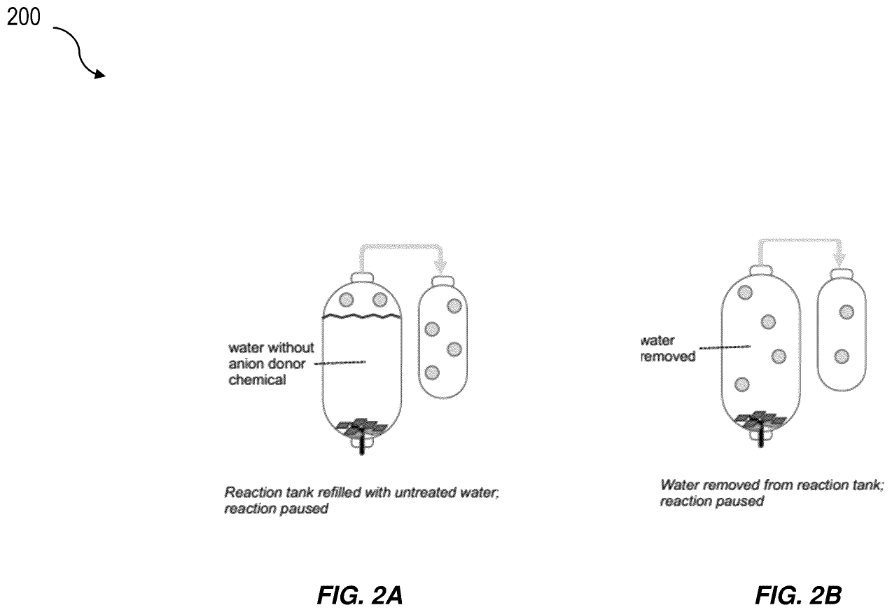

FIGS. 1A-1F and 2A-2B illustrate an example implementation of a system and process for generating hydrogen from aluminum and water according to the subject matter described herein. As shown in FIG. 1A, a system 100, 200 can be configured to generate hydrogen and aluminum salts from aluminum and water according to the steps illustrated in FIGS. 1A-1F and 2A-2B. The steps illustrated in FIGS. 1A-2B, can be performed in any order, allowing flexibility in configuring the system and methods herein for hydrogen production.

The system 100, 200 can include a reaction vessel as shown in FIGS. 1A-2B. The reaction vessel can be considered a reactor in which a hydrogen production reaction occurs. The reaction vessel can include or be coupled to a stirring device, such as a mechanical stirring device. The mechanical stirring device can be positioned at or adjacent to an inferior or bottom portion of the reaction vessel. The mechanical stirring device can be configured to mix the contents of the reaction vessel. In some embodiments, the mechanical stirring device can be a magnetic stirring device, an impeller, or the like. The reaction vessel can be a substantially sealed enclosure including at least one opening configured to receive water, anion donor chemicals, aluminum, or the like. The reaction vessel can also include at least one valve or opening configured to allow hydrogen gas to be released therefrom. Additional valves for input of materials or release of products, including the produced hydrogen and aluminum salts, can also be envisioned. In some embodiments, the system 100, 200 can also include a fill tank fluidically coupled to the reaction vessel and configured to receive hydrogen gas from the reaction vessel as will be described herein. In some embodiments, multiple reaction vessels can be fluidically coupled together.

As shown in FIG. 1B, water and anion donor chemicals can be added to the reaction vessel. The water can be freshwater or saltwater, including seawater, making the system highly adaptable to various environments. The anion donor chemicals can be dissolved in the reaction water. In some embodiments, the anion donor chemicals can include sodium citrate. The anion donor chemicals can facilitate the formation of water-soluble aluminum salts as reaction byproducts. The anion donor chemicals can include a soluble acid. In certain embodiments, the soluble acid can include citric acid, oxalic acid, nitric acid, sulfuric acid, phosphoric acid, hydrogen chloride, or hydrogen fluoride. In some embodiments, the anion donor chemicals can include sodium bicarbonate or acetic acid (or an acetate ion resulting from the reaction of acetic acid and water). The anion donor chemicals can also include a buffer solution. In some embodiments, the buffer solution can include dissolved sodium citrate and citric acid. In some embodiments, the buffer solution can include solely basic compounds, such as solely sodium citrate or solely sodium oxalate. In some embodiments, the anion donor chemicals can include an aqueous or protic solution containing concentrations of dissolved anion donor(s).

As shown in FIG. 1C, a corrosion agent, such as liquid gallium or a liquid eutectic such as gallium-indium, can be added to or placed at the bottom of the reaction vessel. The corrosion agent can corrode the passivating aluminum oxide layer on the aluminum's surface during the reaction.

In some embodiments, an accelerant chemical, such as caffeine, may also be added to the reaction water to speed up the reaction. In some embodiments, the accelerant chemical can include chelating agents that have anti-corrosion properties for metals. The accelerant chemical can reduce the time required for the aluminum-water reaction to reach a high state of completion. Experimental data indicates that the reaction produces greater better than 85% of the theoretical hydrogen yield within 24 hours. In the presence of an accelerant, the reaction produces better than 85% of the theoretical hydrogen yield within 2-3 hours.

As shown in FIG. 1D, raw aluminum can be introduced into the reaction vessel to start the hydrogen production reaction. Agitation, via the mechanical stirring device, can be initiated to improve mixing between the aluminum and the corrosion agent. In some embodiments, the aluminum can include primary aluminum or secondary aluminum, such as scrap aluminum. In some embodiments, the aluminum can be inert aluminum. In some embodiments, the aluminum need not be pre-activated aluminum or require activation of the aluminum. The aluminum can contain metal or non-metal contaminants, such as plastic coatings as found in beverage cans. The form factor of the aluminum can vary. It can be advantageous to introduce aluminum that is dense enough to sink to the bottom of the reaction vessel and contact the corrosion agent, even in the presence of the mechanical stirring device.

As shown in FIG. 1E, hydrogen production can be initiated responsive to actuating the mechanical stirring device. Rotation of the mechanical stirring device can ensure consistent contact between the aluminum and the corrosion agent. The corrosion agent corrodes an aluminum oxide layer of the aluminum, exposing raw aluminum (Al₀) to the reaction water. As the aluminum interacts with the corrosion agent, the passivating aluminum oxide layer on the surface of the aluminum material is corroded, exposing raw aluminum (Al₀) to water. Once exposed, the aluminum reacts with water in the presence of the dissolved anion donors to produce hydrogen, along with heat, and aluminum byproducts (e.g., Al(OH)₃ and/or other aluminum salts).

As further shown in FIG. 1E, the evolved hydrogen can be captured from the reactor vessel, such as via a valve atop the reaction vessel, and can be delivered directly to the end-use application or stored within a storage vessel, such as the fill tank illustrated. Over time, the hydrogen self-pressurizes within the fill tank to a high and useful pressure. In some embodiments, the pressure within the fill tank can be between 350 bar and 700 bar. In some embodiments, the system 100, 200 can include a cooling mechanism, such as a heater exchanger. As the reaction water heats up and begins to boil steam can be produced. The steam can be condensed and removed using the cooling mechanism fluidically coupled to the reaction vessel. In some embodiments, the cooling mechanism can include a tube-in-tube heat exchanger.

As shown in FIG. 1F, the reaction has reached a completed state in which the aluminum is fully consumed and the reaction vessel contains water laden with byproducts and the corrosion agent. Beneficially, the corrosion agent is not consumed during the hydrogen generation reaction and can be reused continuously. In some embodiments, over time, the anion donor chemicals are consumed and replaced by the dissolved aluminum salts, which can have economic value and can be recovered from the reaction vessel. The reaction water and anion donor chemicals can be refreshed as needed to sustain long-term operation of the hydrogen production reaction.

In another embodiment of the system 100 shown and described in relation to FIGS. 1A-1F, the system 200 shown in FIGS. 2A-2B can be configured to pause or stop the hydrogen production reaction and/or to refresh the reaction water. In this way, the hydrogen production reaction can be metered to achieve desired operating condition or production requirements. For example, as shown in FIG. 2A, the water laden with reaction byproduct (as shown in FIG. 1F), can be removed stopping the hydrogen production reaction and the corrosion agent and the aluminum can be extracted from the reaction vessel. The hydrogen production reaction can be metered or controlled by controlling the addition of aluminum or by running the reaction without sufficient anion donor chemicals and then replenishing the anion donor chemicals as needed.

In some embodiments, the reaction vessel can be refilled with untreated water the anion donor chemicals are consumed and replaced by dissolved aluminum salts. As shown in FIG. 2B, in some embodiments, the water can be removed from the reaction vessel to fully pause or stop the hydrogen production reaction. The water-soluble aluminum salts, such as aluminum citrate, may be extracted from the reaction water for sale, offering additional economic benefits for use in the production of gels in oil and gas production, pharmaceuticals, and deodorants. The aluminum salts can also be important precursor chemicals in water purification, vaccine production, paper production, and other industrial processing or production applications.

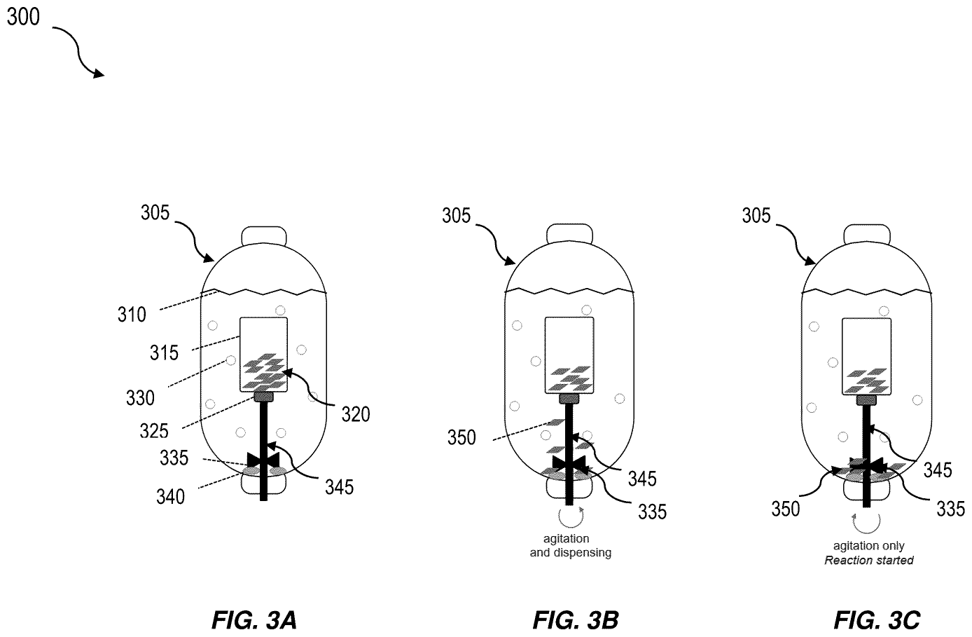

FIGS. 3A-3C illustrate another embodiment of the system 100, 200 in which a material dispenser can be configured within the reactor vessel for dispensing material therein to start, adjust, or otherwise control the hydrogen generation reaction described herein. For example, as shown in FIGS. 3A-3C, the system 300 can include a reactor vessel 305 containing water 310, anion donor chemicals 330, a material dispenser 315 retaining a material 320, such as aluminum, a stirring device 335, and a corrosion agent 340. The material 320 can include non-activated aluminum that can be stored within material dispenser 315 at a location within the reactor vessel 305 that is under a surface level of the water 310. In some embodiments, such as when pressure is generated, the systems described herein can be configured to limit the number of penetrations or openings in the reactor vessel 305. Moreover, in high pressure applications using a lightweight reactor, these penetrations can be limited to being positioned at the poles or upper and lower ends of the reactor vessel 305. In some embodiments, a driveshaft 345 can be configured within the reactor vessel 305 and the drive shaft can be operably coupled to at least one of the stirring device 335 and the material dispenser 315. Rotation of the driveshaft 345 can be configured to rotate the stirring device 335 and actuate the material dispenser, either separately or in unison. Actuation of the driveshaft 345 via magnets is less desirable because magnets do not produce sufficient torque needed to actuate the stirring device 335 and/or the material dispenser 315.

As shown in FIG. 3A, the driveshaft 345 includes a sealing component, such as a pressure seal or gasket. The stirring device 335 can be rigidly attached to the driveshaft 345. This driveshaft 345 also has a one-way slip bearing 325 that can be coupled to the material dispenser 320. Rotation of the driveshaft 345 can cause the material 320 retained within the material dispenser 320 to be dispensed within the reactor vessel 305.

For example, as shown in FIG. 3B, the driveshaft 345 can be rotated in a counter-clockwise direction, which can cause the stirring device 345 and the material dispenser 315 to operate. Dispensed material 350 can be expelled from the material dispenser 315 and can move toward the bottom of the reactor vessel 305 where the corrosion agent 340 is present. In some embodiments, rotation of the driveshaft 345 can be configured to dispense a single dose of the material 320 retained in the material dispenser 320 as the dispensed material 350. In some embodiments, rotation of the driveshaft 345 can cause more than a single dose of the material 320 to be dispensed, such as a quarter, a half, or all of the material 320.

As shown in FIG. 3C, the driveshaft 345 is rotated clockwise, which can cause only the stirring device 335 to rotate. In this direction, the one-way slip bearing 325 can be configured to rotate freely and does not cause the material dispenser 315 to dispense the material 320 stored therein.

In the embodiments shown in FIGS. 3A-3C, the material 320 may exclude pre-activated aluminum since the pre-activated aluminum would react as soon as it becomes in contact with steam or other humidity inside the reactor vessel 305 when it is dispensed as dispensed material 350. The packing factor of aluminum nuggets stored as material 320 in the material dispenser 315 is roughly 50% efficient. That means, activated aluminum stored in air or an inert gas will have 50% of its volume occupied by this gas. When generating pressurized hydrogen, this volume of gas is non-trivial and can significantly impact the efficiency of the reactor vessel 305. For example, in such situations, the reactor vessel 305 must produce lots of extra hydrogen to fill the extra headspace above and beyond what is needed to fill a fill-vessel, which can be coupled to the reactor vessel 305 to collect the generated hydrogen (as shown in FIGS. 1A-2B). In some case, such situations can require the reactor vessel 305 to create two-times (2×) the objective hydrogen quantity. In the embodiments described herein using non-activated aluminum as the material 320, the headspace of the reactor vessel 305 can be filled with water, an incompressible liquid and thus, there is no need to generate extra hydrogen. The non-activated aluminum can be stored within the reactor vessel 305, such as in the material dispenser 320, or can be added to the reactor vessel 305, for example, through one or more sidewall ports of the reactor vessel 305. In both cases, the headspace would be nearly zero as it can be safely filled with water.

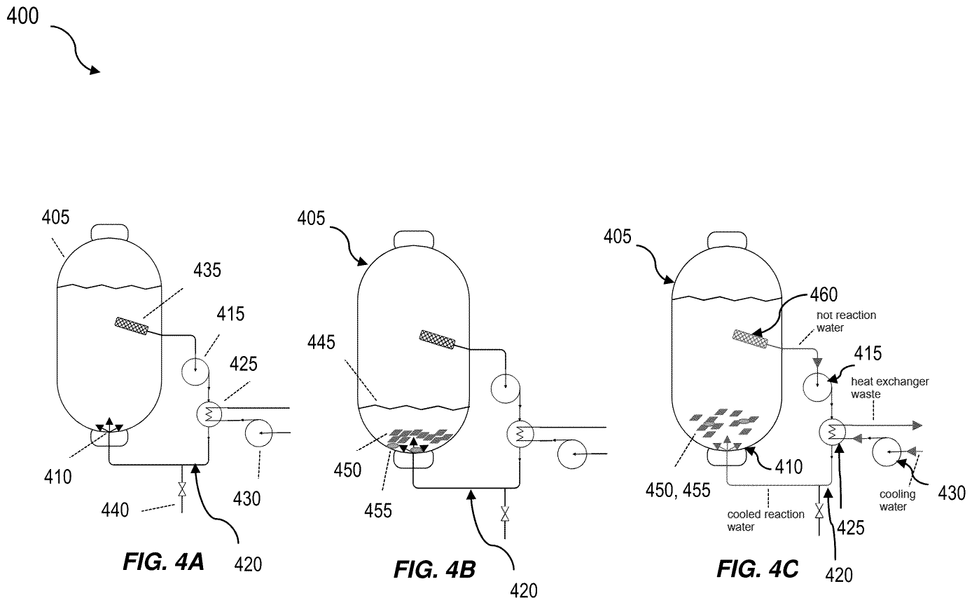

FIGS. 4A-4C illustrate another embodiment of the system 100, 200 in which a recirculation pump can be coupled to the reactor vessel for fluidic mixing or stirring of the contents of the reactor vessel. The use of fluidic mixing or stirring can be used in addition to or configured separately from the use of mechanical mixing or stirring as described herein. As shown in FIG. 4A, the reactor vessel 405 can include one or more fluidic conduits or jets 410 configured to provide fluidic mixing. A recirculation pump 415 can be fluidically coupled to the reactor vessel 405. The recirculation pump 415 can be coupled to the reactor vessel 405 via a recirculation loop 420 can also include a heat exchanger 425 and a heat exchanger pump 430 configured to control reaction water temperature.

As shown in FIG. 4B, during system initialization water 445 is gradually introduced into the reactor vessel 405 via inlet valve 440 so as to cover the aluminum 450 and the corrosion agent 455. As shown in FIG. 4C, when controlling the reaction water temperature, the inlet of the recirculation pump 415 can receive hot reaction water from the reactor vessel 405. The received reaction water contains suspended reaction byproduct, oxidation materials, aluminum, and corrosion agents. A filter 460, such as a mesh having a properly selected mesh size (e.g., nominally 30 mesh) can prevent disruptive media from being circulated though the pump 415 and optionally, heat exchanger 425.

The return supplied to the reactor vessel 405 is by way of the jets 410 positioned at the bottom of the reactor vessel 405 under the aluminum 450. The jets 410 serve to both introduce fresh water at a location where the corrosion agent 455 is actively in contact with un-activated aluminum 450 and to help clear away oxidation materials. Because the mass of aluminum is quite large, using mechanical agitation only would require very robust and heavy components for mixing. Likewise using only fluidic mixing, such as via jets 410, requires oversizing pumps to make sure there is always sufficient agitation. By using a hybrid mixing method including use of fluid and mechanical mixing, the system 400 achieves a more balanced design in view of these constraints.

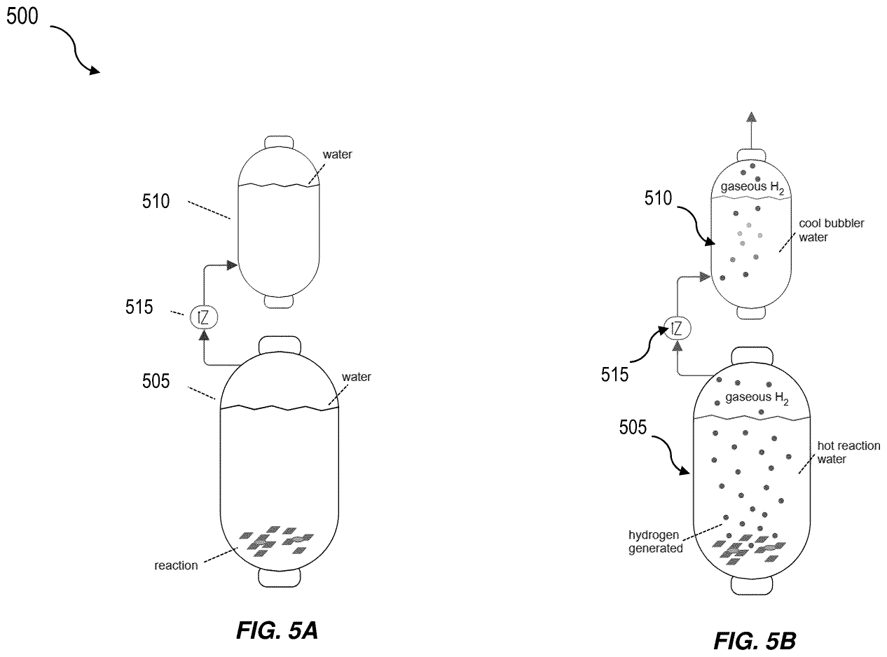

FIGS. 5A-5B illustrate another embodiment of the systems 100, 200 configured to include a cooling reservoir, sometimes referred to a bubbler. As shown in FIG. 5A, the system 500 includes a cooling reservoir 510 configured above the reactor vessel 505. A check valve 515 is configured between the cooling reservoir 510 and the reactor vessel 505. The check valve 515 can be configured to allow Hydrogen and steam to pass from reactor vessel 505 to cooling reservoir 510 without draining the cooling reservoir 510 and without gas or fluid in the cooling reservoir 510 passing back to the reactor vessel 505.

In operation, the fluid path extending through the check valve 515 can be configured such that any roiling or bubbling within the reactor vessel 505 does not splash into a region proximate to the check valve 515. In some embodiments, the check valve 515 can include a mesh screen implemented in a vertical manner such that any aluminum would fall back to the reactor vessel 505.

In this embodiment the reactor water naturally limits steam production and the cooling reservoir 510 can further reduce steam in the output hydrogen.

The embodiment of FIGS. 5A-5B is configured to mitigate issues that may arise using a tube-in-tube heat exchanger. For example, in low pressure systems when hydrogen is generated at very fast rates a tube-in-tube heat exchanger requires very sizes large to accommodate the gas flow and it can be very difficult to remove all of the steam produced. Likewise, if there are extra particulates in the Hydrogen gas flow they would likely flow through the tube-in-tube heat exchanger.

Advantageously, the embodiment shown in FIGS. 5A-5B reduces the complexity of steam knockout and can also be configured to filter most or all of the non-hydrogen particulates. The cooling reservoir 510 can support high hydrogen flow rates. The cooling reservoir 510 can be actively cooled using a heat exchanger or, in some embodiments, the cooling reservoir 510 can be partially drained and refilled with cool water. By monitoring the water temperature of the cooling reservoir it is possible to know if steam is likely to be present in the output hydrogen.

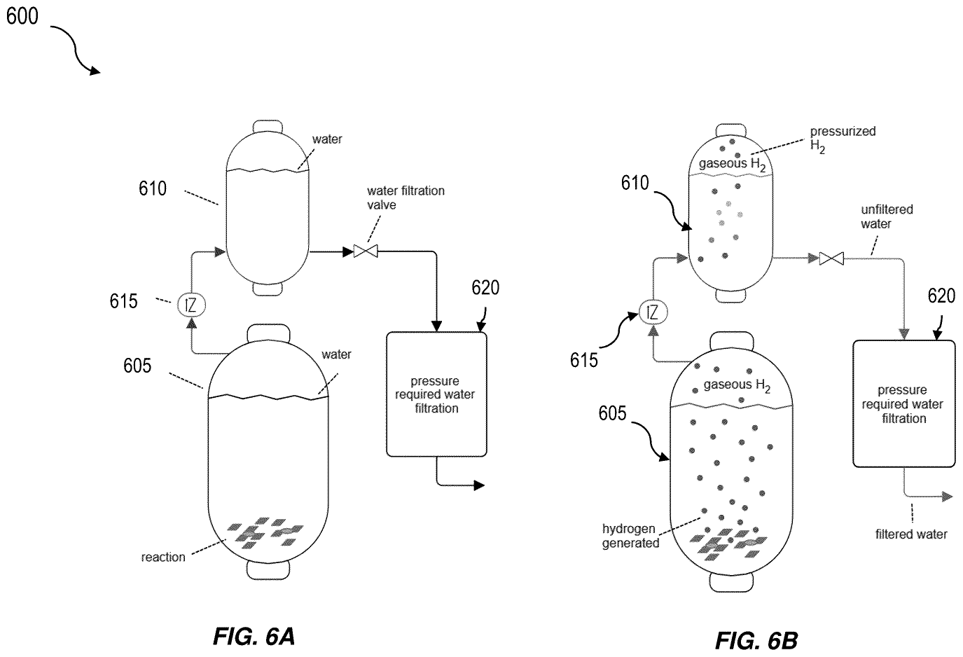

FIGS. 6A-6B illustrate another embodiment of system 100, 200 configured to utilized pressurized Hydrogen for water filtration. For example, as shown in FIG. 6A, instead of allowing the Hydrogen gas to exit the system 600 the Hydrogen gas can be used to pressurize one or more components of the system. For example, the accumulated pressure can be used to pressurize an outflow from the cooling reservoir 610. In this way, a tank 620 of water can be pressurized to system pressure without the need of pump or a booster pump. The water from the cooling reservoir 610 is nominally non-contaminated by the reaction water. As with reactor water, the water from the cooling reservoir 610 need not be clean. Oftentimes water from the cooling reservoir 610 is scavenged ground water.

A broad range of applications can utilize the self-pressurized water output from the cooling reservoir 610. For example, as shown in FIG. 6B, the pressurized water can be used to run a water filter (via forced gravity or reverse osmosis) associated with the tank 620. Reverse osmosis usually needs high pressure and often require heavy booster pumps that require significant amounts of power to operate. Advantageously, the system 600 can start with scavenged water, produce Hydrogen, electricity (e.g., such as hydrogen though a fuel cell), and clean water without the need for expensive pumps or additional processing components.

### EXPERIMENTAL DATA

The following includes experimental data associated with the systems and methods of producing hydrogen described according to the subject matter herein.

### Example 1

The spin rate and starting temperature were free variables. For most experiments, the stirring rate was fixed. Tests A1-E4 were performed in Erlenmeyer flasks. The flasks were open at the top to ambient air. Anion donors were dissolved into water. Different types of water were used: water purified by reverse osmosis (RO), deionized water, and tap water. Aluminum was added. Then, a corrosion agent (GaIn eutectic) was added. Reaction start and end (if applicable) were documented. At the end of reaction the amount of remaining aluminum was noted. Most experiments were terminated after several hours, some allowed to run for 24-48 hours. Hydrogen production was visually observed and correlated to the amount of aluminum left intact at the bottom of the vessel. These tests provided visual indications of the hydrogen production reaction and enabled observation of the aluminum as being completely consumed, partially consumed, or only minimally consumed (e.g., a condition in which the hydrogen production reaction was observed to be “stalled”). Tests F1-F4 were performed in a reaction vessel rated to a maximum pressure of 50 psig. This allowed calculation of an amount of hydrogen produced based on the final pressure value inside the reaction vessel. The percentage values shown in the “Result” column represent the percent of a theoretical maximum amount of hydrogen that was produced based on the available headspace in the reaction vessel and the final pressure inside the reaction vessel.

Tables 1 and 2, below, summarize experimental data associated with a plurality of experiments (e.g., Test IDs) performing the methods of hydrogen production described herein using the system 100, 200. For the experiments summarized in Table 1, sodium citrate was used as the anion donor and GaIn eutectic was used as the corrosion agent. For the experiments summarized in Table 2, the anion donors used are as indicated in the table and the corrosion agent was GaIn eutectic. As shown, a number of variables were controlled during each experiment, including pressure, an amount (grams) of corrosion agent, an amount (grams) of aluminum, an amount (mL) of water, a temperature (degrees Celsius) of water, a type of water, a salt type (e.g., a concentration of salt in the water), an amount (grams) of an anion donor chemical, an agitation method, a material containment method, a duration (minutes or hours as indicated) of the experiment, and, in some instances, an amount (grams) of an accelerant. A characterization of a result of the experiment and/or a percentage completion of the hydrogen production reaction is also provided.

TABLE 1
Summary of experimental results (sodium citrate)

| Test | | | Corrosion | AL | Water | | | |
|---|---|---|---|---|---|---|---|---|
| ID | Date | Pressure | Agent (g) | (g) | (ml) | Temp | Type | Salt |
| A1 | Dec. 1, 2024 | Ambient | 1.0 | 1 | 200 | 25 | Distilled | |
| A2 | Dec. 1, 2024 | Ambient | 0.4 | 1 | 200 | 35 | Distilled | |
| A3 | Dec. 1, 2024 | Ambient | 0.4 | 1 | 200 | 35 | Distilled | |
| B1 | Dec. 4, 2024 | Ambient | 0.4 | 1 | 300 | 40 | Distilled | |
| B2 | Dec. 4, 2024 | Ambient | 0.4 | 1 | 300 | 40 | Distilled | |
| B3 | Dec. 4, 2024 | Ambient | 1.0 | 1 | 300 | 16 | Distilled | |
| B4 | Dec. 4, 2024 | Ambient | 1.0 | 1 | 300 | 16 | Ocean | Seawater |
| B5 | Dec. 4, 2024 | Ambient | 1.0 | 1 | 300 | 16 | Distilled | |
| B6 | Dec. 4, 2024 | Ambient | 1.0 | 1 | 300 | 16 | Distilled | |
| B7 | Dec. 4, 2024 | Ambient | 1.0 | 1 | 300 | 16 | Ocean | Seawater |
| C1 | Dec. 5, 2024 | Ambient | 0.4 | 1 | 300 | 16 | Distilled | |
| C2 | Dec. 5, 2024 | Ambient | 0.4 | 1 | 300 | 16 | Ocean | Seawater |
| C3 | Dec. 5, 2024 | Ambient | 0.4 | 1 | 300 | 16 | Distilled | |
| C4 | Dec. 5, 2024 | Ambient | 0.4 | 1 | 300 | 16 | Distilled | |
| C5 | Dec. 5, 2024 | Ambient | 0.4 | 1 | 300 | 16 | Ocean | Seawater |
| D1 | Dec. 6, 2024 | Ambient | 0.2 | 1 | 200 | 16 | Distilled | |
| D2 | Dec. 6, 2024 | Ambient | 0.2 | 1 | 200 | 16 | Distilled | Diluted |
| D3 | Dec. 6, 2024 | Ambient | 0.2 | 1 | 200 | 16 | Distilled | Brackish |
| D4 | Dec. 6, 2024 | Ambient | 0.2 | 1 | 200 | 16 | Distilled | Seawater |
| D5 | Dec. 6, 2024 | Ambient | 0.2 | 1 | 200 | 16 | Distilled | Seawater |
| D6 | Dec. 6, 2024 | Ambient | 0.2 | 1 | 200 | 16 | Tap | |
| D7 | Dec. 6, 2024 | Ambient | 0.2 | 1 | 200 | 16 | Tap | |
| D8 | Dec. 6, 2024 | Ambient | 0.2 | 1 | 200 | 16 | Tap | Brackish |
| E1 | Dec. 9, 2024 | Ambient | 0.2 | 1 | 200 | 16 | Distilled | Diluted |
| E2 | Dec. 9, 2024 | Ambient | 0.2 | 1 | 200 | 16 | Distilled | Diluted |
| E3 | Dec. 11, 2024 | Ambient | 0.2 | 1 | 200 | 16 | Distilled | Diluted |
| E4 | Dec. 11, 2024 | Ambient | 0.2 | 1 | 200 | 16 | Distilled | Diluted |
| F1 | Dec. 9, 2024 | Vessel | 2.3 | 18 | 1350 | 16 | Distilled | |
| F2 | Dec. 10, 2024 | Vessel | 2.3 | 18 | 1350 | 16 | Distilled | |
| F3 | Dec. 11, 2024 | Vessel | 2.3 | 18 | 2500 | 16 | Distilled | |
| F4 | Dec. 12, 2024 | Vessel | 6.0 | 18 | 2500 | 16 | Distilled | |

| Test | Anion | Agitation | Material | | Duration | Accelerant |
|---|---|---|---|---|---|---|
| ID | Donor (g) | Method | Containment | Result | (hr) | (g) |
| A1 | 7.5 | Mag spin | None | Complete | 60 | |
| A2 | 7.5 | Mag spin | None | Complete | 48 | |
| A3 | 0.0 | Mag spin | None | Stalled | 48 | |
| B1 | 7.5 | Mag spin | None | Complete | 48 | |
| B2 | 0.0 | Mag spin | None | Stalled | 48 | |
| B3 | 7.5 | Mag spin | None | Stalled | 48 | |
| B4 | 0.0 | Mag spin | None | Stalled | 48 | |
| B5 | 7.5 | Mag spin | None | Partial | 48 | |
| B6 | 7.5 | Mag spin | None | Complete | 48 | 0.3 |
| B7 | 7.5 | Mag spin | None | Complete | 48 | |
| C1 | 7.5 | Mag spin | None | Complete | 48 | |
| C2 | 0.0 | Mag spin | None | Stalled | 48 | |
| C3 | 7.5 | Mag spin | None | Stalled | 48 | |
| C4 | 7.5 | Mag spin | None | Complete | 48 | 0.3 |
| C5 | 7.5 | Mag spin | None | Complete | 48 | |
| D1 | 10.0 | Mag spin | None | Complete | 48 | |
| D2 | 10.0 | Mag spin | None | Complete | 48 | |
| D3 | 10.0 | Mag spin | None | Complete | 48 | |
| D4 | 10.0 | Mag spin | None | Complete | 48 | |
| D5 | 10.0 | Mag spin | None | Complete | 48 | |
| D6 | 0.0 | Mag spin | None | Complete | 48 | |
| D7 | 10.0 | Mag spin | None | Complete | 48 | |
| D8 | 10.0 | Mag spin | None | Complete | 48 | |
| E1 | 10.0 | Stirrer A | None | Complete | 24 | |
| E2 | 10.0 | Stirrer B | None | Complete | 24 | |
| E3 | 10.0 | None | 5u mesh | Partial | | |
| E4 | 10.0 | None | Disparate bag | No Reaction | | |
| F1 | 150.0 | Impeller | None | 96.4% | 21 | |
| F2 | 150.0 | Impeller | None | 99.5% | | 1.0 |
| F3 | 200.0 | Impeller | None | 99.9% | | 1.0 |
| F4 | 200.0 | Impeller | None | | | 1.0 |

TABLE 2
Summary of experimental results (additional anion donors)

| | | | | | Al | | | | | | |
|---|---|---|---|---|---|---|---|---|---|---|---|
| | | | | | Source | | | | | Time to | |
| | | | | | (93% | | | | Corrosion | Completion (min) | |
| | Anion donor | | | | Al) | Water | | | Agent | min | max |
| | | Number | Amount (g) | | Amount | V | T | | Amount | Min | Max |
| Pressure | Type | of Tests | Min | Max | (g) | (ml) | (° C.) | Type | (g) | (min) | (min) |
| Ambient | Sodium Citrate | 368 | 2.0 | 12.0 | 1 | 200 | 60 | RO | 0.6 | 180 | 1440 |
| Ambient | Oxalic acid | 4 | 5.0 | 10.0 | 1 | 200 | 60 | RO | 0.6 | 18 | 30 |
| Ambient | Vinegar | 40 | 4.0 | 20.0 | 1 | 200 | 60 | RO | 0.6 | 20 | 1440 |
| Ambient | Sodium acetate | 2 | 8.0 | 14.0 | 1 | 200 | 60 | RO | 0.6 | 120 | 1440 |
| Ambient | Lactic acid | 13 | | 9.5 | 1 | 200 | 60 | RO | 0.6 | 30 | |
| Ambient | Lysine | 1 | | 19.0 | 1 | 200 | 60 | RO | 0.6 | 180 | |
| Ambient | Tartaric acid | 56 | 4.0 | 16.0 | 1 | 200 | 60 | RO | 0.6 | 25 | 60 |
| Ambient | Sodium | 1 | 1.4 | 2.0 | 1 | 200 | 60 | RO | 0.6 | | 1440 |
| | Hydroxide | | | | | | | | | | |
| Ambient | Citric Acid | 28 | 2.2 | 17.5 | 1 | 200 | 60 | RO | 0.6 | | 120 |
| | Anhydrous | | | | | | | | | | |
| Ambient | Potassium | 3 | | | 1 | 200 | 60 | RO | 0.6 | | 720 |
| | Citrate | | | | | | | | | | |
| Ambient | Boric acid | 1 | | 6.5 | 1 | 200 | 60 | RO | 0.6 | | 360 |
| Ambient | Sodium lactate | 2 | 2.0 | 12.0 | 1 | 200 | 60 | RO | 0.6 | | 1440 |
| Ambient | Sodium Chloride | 4 | | 6.0 | 1 | 200 | 60 | RO | 0.6 | | 360 |

In the experiments described herein, sodium citrate (Na₃C₆H₅O₇), vinegar (CH₃COOH), sodium acetate (CH₃COONa), lactic acid (C₃H₆O₃), lysine (C₆H₁₄N₂O₂), and oxalic acid (C₂H₂O₄) generally facilitated the fastest conversions with additional anion donors facilitating conversion but at slower rates.

### Example 2

It was found that, in some embodiments of the process described herein, an optimal reaction temperature is between 60-80° C. However, pre-heating the water requires energy. A novel method was developed herein which comprises starting the reaction with a small amount of reaction water that contains the anion donor at a high concentration. The exothermic reaction is able to quickly heat the small amount of water to the optimal temperature. Then more (colder) water is pumped into the reactor, which is subsequently heated by the reaction. This continues until the reactor has reached its maximum water capacity. Without wishing to be bound by theory, in some embodiments, an anion donor concentration is chosen such that the reaction water reaches a desired concentration level by the time the reactor is fully filled with water.

The subject matter herein provides a number of technical advantages over existing hydrogen production systems and methods of operation. For example, the aforementioned systems and methods eliminate the need to pre-activate aluminum, avoiding the use of expensive, difficult to source, and geopolitically sensitive activation materials such as gallium, indium, tin, and bismuth in consumable form.

The subject matter herein also provides a number of technical advantages over existing aluminum salt production. Existing methods require strong acids and bases, which are hazardous and environmentally detrimental. The resulting aluminum salts produced using existing methods are typically mixed with other salts in aqueous form, and therefore challenging to separate with high purity.

Additionally, the systems and methods described herein provide significant scalability and flexibility of hydrogen production. The slower reaction rate achieved herein, compared to those of activated aluminum systems, enables safe and efficient hydrogen production at high pressures (e.g., between 350-700 bar) without requiring large headspace within the reactor vessel. As compared to systems and methods utilizing an electrolyzer, the systems and methods herein provide unlimited scaling of hydrogen production without the need to build expensive electrolyzer stacks, and without the need for gas compressors that require significant infrastructure and electrical power. The systems and methods enable continuous hydrogen generation with improved heat management and a simplified reactor design. The systems and methods can scale to meet diverse hydrogen needs by increasing the amount of corrosion agent or operating multiple reaction vessels in parallel.

By enabling point-of-need hydrogen production, the systems and methods described herein eliminate the logistical challenges of hydrogen storage and transport. For example, the systems and methods described herein can be configured to operate using compact or low-foot print reaction vessels, capable of fitting in the back of a pickup truck, which use readily available feedstocks, such as aluminum, water, and requisite additive materials, making them ideal for infrastructure and logistics constrained environments. Such compact reaction vessel design can provide significant advantages in hydrogen production applications including construction, mining, agriculture, and defense applications, such as power generation, refueling electric manned or unmanned vehicles used in construction and mining, water purification, and lift gas production for lighter-than-air vehicles. The environmental benefits of the systems and methods described herein can include reduced CO2 emissions and the use of scrap aluminum as an aluminum material source.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A mixture comprising water, an anion donor composition, an aluminum corrosion agent, and an aluminum source; wherein the aluminum source does not comprise activated alumina.

2. The mixture of claim 1, wherein the anion donor composition comprises sodium citrate.

3. The mixture of claim 1, wherein the anion donor composition comprises vinegar, sodium acetate, lactic acid, lysine, oxalic acid, citric acid, sodium hydroxide, sodium chloride, potassium citrate, boric acid, sodium lactate, sodium acetate trihydrate, or tartaric acid.

4. (canceled)

5. The mixture of claim 1, wherein the mixture comprises from about 2 g to about 25 g of anion donor composition per 1 g of aluminum source.

6-13. (canceled)

14. The mixture of claim 1, wherein the aluminum corrosion agent comprises gallium.

15. The mixture of claim 1, wherein the aluminum corrosion agent is gallium-indium eutectic.

16-19. (canceled)

20. The mixture of claim 1, wherein the mixture comprises at from about 0.1 g to about 2 g of aluminum corrosion agent per 1 g of aluminum source.

21-24. (canceled)

25. The mixture of claim 1, wherein the aluminum source is an aluminum alloy.

26. The mixture of claim 1, wherein the aluminum source comprises from about 90% to about 100% aluminum.

27. (canceled)

28. The mixture of claim 1, wherein the water is tap water.

29-30. (canceled)

31. A process of making hydrogen, comprising:
providing a mixture comprising water and an anion donor composition into a reaction vessel;
adding to said mixture an aluminum corrosion agent and an aluminum source; wherein the aluminum source does not comprise activated alumina, and
collecting hydrogen gas formed by the reaction of said water with aluminum provided by said aluminum source.

32-41. (canceled)

42. The process of claim 1, wherein the corrosion agent is not consumed during the process.

43-52. (canceled)

53. The process of claim 31, wherein the anion donor composition comprises sodium citrate.

54. The process of claim 31, wherein the anion donor composition comprises vinegar, sodium acetate, lactic acid, lysine, oxalic acid, citric acid, sodium hydroxide, sodium chloride, potassium citrate, boric acid, sodium lactate, sodium acetate trihydrate, or tartaric acid.

55-59. (canceled)

60. The process of claim 31, wherein the process comprises from about 2 g to about 25 g of anion donor composition per 1 g of aluminum source.

61-68. (canceled)

69. The process of claim 31, wherein the aluminum corrosion agent comprises gallium.

70. The process of claim 31, wherein the aluminum corrosion agent is gallium-indium eutectic.

71-75. (canceled)

76. The process of claim 31, wherein the aluminum source is an aluminum alloy.

77. The process of claim 31, wherein the aluminum source comprises from about 90% to about 100% aluminum.

78. (canceled)

79. The process of claim 31, wherein the water is tap water.

80-81. (canceled)
